(19) United States
(12) Patent Application Publication
(10) Pub. No.: US 2022/0188921 A1
(43) Pub. Date: Jun. 16, 2022

(54) COMPUTER-IMPLEMENTED METHOD, SYSTEM, AND PRODUCT FOR PROCESSING A LOAN REQUEST

(71) Applicant: VISA INTERNATIONAL SERVICE ASSOCIATION, San Francisco, CA (US)

(72) Inventors: Yogesh Kumar, Bangalore (IN); Animesh Mishra, Kanpur (IN); Abhishek Sanwaliya, Bangalore (IN)

(21) Appl. No.: 17/439,872

(22) PCT Filed: Jun. 21, 2019
(86) PCT No.: PCT/US2019/038406

§ 371 Date: Sep. 16, 2021

(51) Int. Cl. G06Q 40/02; G06Q 30/02

(52) U.S. Cl. CPC G06Q 40/025; G06Q 30/0205

(57) ABSTRACT

A computer-implemented method includes: obtaining a loan request for a first amount associated with a first merchant in a first geographic region; obtaining merchant data associated with the first merchant and a plurality of second merchants; generating, based on the merchant data, a peer-to-peer risk score associated with the first merchant relative to the second merchants; based on the peer-to-peer risk score associated with the first merchant, generating a loan decision for the first merchant; and communicating a loan response to the first merchant including the loan decision.

### CROSS-REFERENCE TO RELATED APPLICATION

This application is the United States national phase of International Application No. PCT/US2019/038406 filed Jun. 21, 2019, the entire disclosure of which is hereby incorporated by reference in its entirety.

### BACKGROUND

### 1. Technical Field

The disclosure relates to processing loan requests and, in some non-limiting embodiments or aspects, to a computer-implemented method, system, and product for generating a peer-to-peer risk score and/or a trigger event during processing of a loan request of a merchant.

### 2. Technical Considerations

A common issue faced by merchants, especially micro and small enterprises (MSEs), is access to financing in order to expand or boost working capital. A MSE may be defined as a merchant having less than $1M in sales per year initiated using electronic payments (e.g., debit and/or credit card transactions). Existing loan processing systems require a time consuming and expensive underwriting process to make loans of any size. As a result, lending institutions are reluctant to lend to MSEs because the costs associated with the underwriting process reduce available profits to the lending institutions. Moreover, increased regulations and limited access to community banking make access to financial capital even more difficult for MSEs. As a result, many MSEs continue to prefer cash and commonly resort to alternative or social lending, slowing their adoption of digital forms of payment.

### SUMMARY

According to some non-limiting embodiments or aspects, a computer-implemented method includes: obtaining, with at least one processor, a loan request for a first amount associated with a first merchant in a first geographic region; obtaining, with at least one processor, merchant data associated with the first merchant and a plurality of second merchants; generating, with at least one processor and based on the merchant data, a peer-to-peer risk score associated with the first merchant, where the peer-to-peer risk score associated with the first merchant is determined relative to the plurality of second merchants; based on the peer-to-peer risk score associated with the first merchant, generating, with at least one processor, a loan decision for the first merchant; and communicating, with at least one processor, a loan response to the first merchant, the loan response including the loan decision.

In some non-limiting embodiments or aspects, the computer-implemented method may further include: determining, with at least one processor, that the first merchant and the plurality of second merchants are associated with a same first market segment of a plurality of market segments and/or the first geographic region. The loan decision may include an approval of the loan request, and the method may further include: controlling, with at least one processor, a lending system to transfer the first amount from an account associated with the lending system to an account associated with the first merchant or an account associated with a supplier of the first merchant.

In some non-limiting embodiments or aspects, the loan decision may include an initial denial of the loan request, and the method may further include: determining, with at least one processor, an alternate loan amount based on the peer-to-peer risk score associated with the first merchant. The loan decision may include an initial denial of the loan request, and the method may further include: determining, with at least one processor, a trigger event that, if completed by the first merchant during a first time period, causes the first merchant to be eligible for a loan for the first amount. The computer-implemented method may further include: determining, with at least one processor, that the first merchant completes the trigger event during the first time period; and communicating an updated loan decision to the first merchant in response to the first merchant completing the trigger event during the first time period. The computer-implemented method may further include: determining, with at least one processor, that the first merchant fails to complete the trigger event during the first time period; determining, with at least one processor, an updated trigger event that, if completed by the first merchant during a second time period, causes the first merchant to be eligible for a loan for the first amount; and communicating an update message to the first merchant, the update message including the updated trigger event.

In some non-limiting embodiments or aspects, the loan decision may include an initial denial of the loan request, and the method may further include: periodically generating, with at least one processor, an updated peer-to-peer risk score associated with the first merchant; and communicating, with at least one processor, the updated peer-to-peer risk score associated with the first merchant to the first merchant. The merchant data may include qualitative and/or quantitative data associated with the first merchant and the plurality of second merchants, where the quantitative data may be associated with a plurality of electronic transactions by the first merchant and/or the plurality of second merchants.

According to some non-limiting embodiments or aspects, a computer-implemented method may include: obtaining, with at least one processor, a loan request for a first amount associated with a first merchant in a first geographic region; obtaining, with at least one processor, merchant data associated with the first merchant; generating, with at least one processor and based on the merchant data, a trigger event that, if completed by the first merchant during a first time period, causes the first merchant to be eligible for a loan for the first amount; and communicating, with at least one processor, a loan response to the first merchant, the loan response including the trigger event.

In some non-limiting embodiments or aspects, the computer-implemented method may further include: obtaining, with at least one processor, merchant data associated with a plurality of second merchants in the first geographic region; and generating, with at least one processor and based on the merchant data, a peer-to-peer risk score associated with the first merchant, where the peer-to-peer risk score associated with the first merchant is determined relative to the plurality of second merchants, where the trigger event is generated based on the peer-to-peer risk score. The computer-implemented method may further include: determining, with at least one processor, that the first merchant and the plurality of second merchants are associated with a same first market segment of a plurality of market segments and/or the first geographic region.

In some non-limiting embodiments or aspects, the computer-implemented method may further include: determining, with at least one processor, that the first merchant completes the trigger event during the first time period; and communicating a loan approval to the first merchant in response to the first merchant completing the trigger event during the first time period. The computer-implemented method may further include: determining, with at least one processor, that the first merchant fails to complete the trigger event during the first time period; determining, with at least one processor, an updated trigger event that, if completed by the first merchant during a second time period, causes the first merchant to be eligible for a loan for the first amount; and communicating an update message to the first merchant, the update message including the updated trigger event. The computer-implemented method may further include: periodically generating, with at least one processor, an updated peer-to-peer risk score associated with the first merchant; and communicating, with at least one processor, the updated peer-to-peer risk score associated with the first merchant to the first merchant. The merchant data may include qualitative and/or quantitative data associated with the first merchant, where the quantitative data may be associated with a plurality of electronic transactions by the first merchant and/or the plurality of second merchants.

According to some non-limiting embodiments or aspects, a system includes at least one processor programmed or configured to: obtain a loan request for a first amount associated with a first merchant in a first geographic region; obtain merchant data associated with the first merchant and a plurality of second merchants; generate, based on the merchant data, a peer-to-peer risk score associated with the first merchant, where the peer-to-peer risk score associated with the first merchant is determined relative to the plurality of second merchants; based on the peer-to-peer risk score associated with the first merchant, generate a loan decision for the first merchant; and communicate a loan response to the first merchant, the loan response including the loan decision.

In some non-limiting embodiments or aspects, the loan decision may include an approval of the loan request, and the at least one processor may be further programmed or configured to: control a lending system to transfer the first amount from an account associated with the lending system to an account associated with the first merchant or an account associated with a supplier of the first merchant. The loan decision may include an initial denial of the loan request, and the at least one processor may be further programmed or configured to: determine an alternate loan amount based on the peer-to-peer risk score associated with the first merchant, where the loan response includes the alternate loan amount. The loan decision may include an initial denial of the loan request, and the at least one processor may be further programmed or configured to: determine a trigger event that, if completed by the first merchant during a first time period, causes the first merchant to be eligible for a loan for the first amount.

According to some non-limiting embodiments or aspects, a system includes at least one processor programmed or configured to: obtain a loan request for a first amount associated with a first merchant in a first geographic region; obtain merchant data associated with the first merchant; generate, based on the merchant data, a trigger event that, if completed by the first merchant during a first time period, causes the first merchant to be eligible for a loan for the first amount; and communicating, with at least one processor, a loan response to the first merchant, the loan response including the trigger event.

According to some non-limiting embodiments or aspects, a computer program product includes at least one non-transitory computer readable medium including program instructions that, when executed by at least one processor, cause the at least one processor to: obtain a loan request for a first amount associated with a first merchant in a first geographic region; obtain merchant data associated with the first merchant and a plurality of second merchants; generate, based on the merchant data, a peer-to-peer risk score associated with the first merchant, where the peer-to-peer risk score associated with the first merchant is determined relative to the plurality of second merchants; based on the peer-to-peer risk score associated with the first merchant, generate a loan decision for the first merchant; and communicate a loan response to the first merchant, the loan response including the loan decision.

According to some non-limiting embodiments or aspects, a computer program product includes at least one non-transitory computer readable medium including program instructions that, when executed by at least one processor, cause the at least one processor to: obtain a loan request for a first amount associated with a first merchant in a first geographic region; obtain merchant data associated with the first merchant; generate, based on the merchant data, a trigger event that, if completed by the first merchant during a first time period, causes the first merchant to be eligible for a loan for the first amount; and communicate a loan response to the first merchant, the loan response including the trigger event.

Further non-limiting embodiments or aspects are set forth in the following numbered clauses:

Clause 1: A computer-implemented method, comprising: obtaining, with at least one processor, a loan request for a first amount associated with a first merchant in a first geographic region; obtaining, with at least one processor, merchant data associated with the first merchant and a plurality of second merchants; generating, with at least one processor and based on the merchant data, a peer-to-peer risk score associated with the first merchant, wherein the peer-to-peer risk score associated with the first merchant is determined relative to the plurality of second merchants; based on the peer-to-peer risk score associated with the first merchant, generating, with at least one processor, a loan decision for the first merchant; and communicating, with at least one processor, a loan response to the first merchant, the loan response comprising the loan decision.

Clause 2: The computer-implemented method of clause 1, further comprising: determining, with at least one processor, that the first merchant and the plurality of second merchants are associated with a same first market segment of a plurality of market segments and/or the first geographic region.

Clause 3: The computer-implemented method of clause 1 or 2, wherein the loan decision comprises an approval of the loan request, and wherein the method further comprises: controlling, with at least one processor, a lending system to transfer the first amount from an account associated with the lending system to an account associated with the first merchant or an account associated with a supplier of the first merchant.

Clause 4: The computer-implemented method of any of clauses 1-3, wherein the loan decision comprises an initial denial of the loan request, and wherein the method further comprises: determining, with at least one processor, an alternate loan amount based on the peer-to-peer risk score associated with the first merchant.

Clause 5: The computer-implemented method of any of clauses 1-4, wherein the loan decision comprises an initial denial of the loan request, and wherein the method further comprises: determining, with at least one processor, a trigger event that, if completed by the first merchant during a first time period, causes the first merchant to be eligible for a loan for the first amount.

Clause 6: The computer-implemented method of any of clauses 1-5, further comprising: determining, with at least one processor, that the first merchant completes the trigger event during the first time period; and communicating an updated loan decision to the first merchant in response to the first merchant completing the trigger event during the first time period.

Clause 7: The computer-implemented method of any of clauses 1-6, further comprising: determining, with at least one processor, that the first merchant fails to complete the trigger event during the first time period; determining, with at least one processor, an updated trigger event that, if completed by the first merchant during a second time period, causes the first merchant to be eligible for a loan for the first amount; and communicating an update message to the first merchant, the update message comprising the updated trigger event.

Clause 8: The computer-implemented method of any of clauses 1-7, wherein the loan decision comprises an initial denial of the loan request, wherein the method further comprises: periodically generating, with at least one processor, an updated peer-to-peer risk score associated with the first merchant; and communicating, with at least one processor, the updated peer-to-peer risk score associated with the first merchant to the first merchant.

Clause 9: The computer-implemented method of any of clauses 1-8, wherein the merchant data comprises qualitative and/or quantitative data associated with the first merchant and the plurality of second merchants, wherein the quantitative data is associated with a plurality of electronic transactions by the first merchant and/or the plurality of second merchants.

Clause 10: A computer-implemented method, comprising: obtaining, with at least one processor, a loan request for a first amount associated with a first merchant in a first geographic region; obtaining, with at least one processor, merchant data associated with the first merchant; generating, with at least one processor and based on the merchant data, a trigger event that, if completed by the first merchant during a first time period, causes the first merchant to be eligible for a loan for the first amount; and communicating, with at least one processor, a loan response to the first merchant, the loan response comprising the trigger event.

Clause 11: The computer-implemented method of clause 10, further comprising: obtaining, with at least one processor, merchant data associated with a plurality of second merchants in the first geographic region; and generating, with at least one processor and based on the merchant data, a peer-to-peer risk score associated with the first merchant, wherein the peer-to-peer risk score associated with the first merchant is determined relative to the plurality of second merchants, wherein the trigger event is generated based on the peer-to-peer risk score.

Clause 12: The computer-implemented method of clause 10 or 11, further comprising: determining, with at least one processor, that the first merchant and the plurality of second merchants are associated with a same first market segment of a plurality of market segments and/or the first geographic region.

Clause 13: The computer-implemented method of any of clauses 10-12, further comprising: determining, with at least one processor, that the first merchant completes the trigger event during the first time period; and communicating a loan approval to the first merchant in response to the first merchant completing the trigger event during the first time period.

Clause 14: The computer-implemented method of any of clauses 10-13, further comprising: determining, with at least one processor, that the first merchant fails to complete the trigger event during the first time period; determining, with at least one processor, an updated trigger event that, if completed by the first merchant during a second time period, causes the first merchant to be eligible for a loan for the first amount; and communicating an update message to the first merchant, the update message comprising the updated trigger event.

Clause 15: The computer-implemented method of any of clauses 10-14, further comprising: periodically generating, with at least one processor, an updated peer-to-peer risk score associated with the first merchant; and communicating, with at least one processor, the updated peer-to-peer risk score associated with the first merchant to the first merchant.

Clause 16: The computer-implemented method of any of clauses 10-15, wherein the merchant data comprises qualitative and/or quantitative data associated with the first merchant, wherein the quantitative data is associated with a plurality of electronic transactions by the first merchant and/or the plurality of second merchants.

Clause 17: A system, comprising at least one processor programmed or configured to: obtain a loan request for a first amount associated with a first merchant in a first geographic region; obtain merchant data associated with the first merchant and a plurality of second merchants; generate, based on the merchant data, a peer-to-peer risk score associated with the first merchant, wherein the peer-to-peer risk score associated with the first merchant is determined relative to the plurality of second merchants; based on the peer-to-peer risk score associated with the first merchant, generate a loan decision for the first merchant; and communicate a loan response to the first merchant, the loan response comprising the loan decision.

Clause 18: The system of clause 17, wherein the loan decision comprises an approval of the loan request, and wherein the at least one processor is further programmed or configured to: control a lending system to transfer the first amount from an account associated with the lending system to an account associated with the first merchant or an account associated with a supplier of the first merchant.

Clause 19: The system of clause 17 or 18, wherein the loan decision comprises an initial denial of the loan request, and wherein the at least one processor is further programmed or configured to: determine an alternate loan amount based on the peer-to-peer risk score associated with the first merchant, wherein the loan response comprises the alternate loan amount.

Clause 20: The system of any of clauses 17-19, wherein the loan decision comprises an initial denial of the loan request, and wherein the at least one processor is further programmed or configured to: determine a trigger event that, if completed by the first merchant during a first time period, causes the first merchant to be eligible for a loan for the first amount.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosure. As used in the specification and the claims, the singular form of “a,” “an,” and “the” include plural referents unless the context clearly dictates otherwise. Further, the phrase “based on” is intended to mean “based at least partially on” unless explicitly stated otherwise.

### BRIEF DESCRIPTION OF THE DRAWINGS

Additional advantages and details of the disclosure are explained in greater detail below with reference to the non-limiting exemplary embodiments that are illustrated in the accompanying schematic figures, in which:

FIG. 1 shows a schematic view of a system for processing a loan request according to some non-limiting embodiments or aspects;

FIG. 2 shows a graphical user interface displaying a loan request according to some non-limiting embodiments or aspects;

FIG. 3 shows a table including a first merchant and a plurality of second merchants within a geographic region according to some non-limiting embodiments or aspects;

FIG. 4 shows a graphical user interface displaying a peer-to-peer risk score and a loan recommendation according to some non-limiting embodiments or aspects;

FIG. 5 shows a graphical user interface displaying a loan response according to some non-limiting embodiments or aspects;

FIG. 6 shows a graphical user interface displaying a loan response according to some non-limiting embodiments or aspects;

FIG. 7 shows a step diagram of a computer-implemented method for processing a loan request according to some non-limiting embodiments or aspects; and

FIG. 8 shows a step diagram of a computer-implemented method for processing a loan request according to some non-limiting embodiments or aspects.

### DETAILED DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the disclosure as it is oriented in the drawing figures. However, it is to be understood that the disclosure may assume various alternative variations and step sequences, except where expressly specified to the contrary. It is also to be understood that the specific devices and processes illustrated in the attached drawings, and described in the following specification, are simply exemplary embodiments or aspects of the disclosure. Hence, specific dimensions and other physical characteristics related to the embodiments or aspects disclosed herein are not to be considered as limiting.

As used herein, the term “acquirer” may refer to an entity licensed by the transaction service provider and approved by the transaction service provider to originate transactions (e.g., payment transactions) using a payment device associated with the transaction service provider. As used herein, the term “acquirer system” may also refer to one or more computer systems, computer devices, and/or the like operated by or on behalf of an acquirer. The transactions the acquirer may originate may include payment transactions (e.g., purchases, original credit transactions (OCTs), account funding transactions (AFTs), and/or the like). In some non-limiting embodiments, the acquirer may be authorized by the transaction service provider to assign merchant or service providers to originate transactions using a payment device of the transaction service provider. The acquirer may contract with payment facilitators to enable the payment facilitators to sponsor merchants. The acquirer may monitor compliance of the payment facilitators in accordance with regulations of the transaction service provider. The acquirer may conduct due diligence of the payment facilitators and ensure that proper due diligence occurs before signing a sponsored merchant. The acquirer may be liable for all transaction service provider programs that the acquirer operates or sponsors. The acquirer may be responsible for the acts of the acquirer's payment facilitators, merchants that are sponsored by an acquirer's payment facilitators, and/or the like. In some non-limiting embodiments, an acquirer may be a financial institution, such as a bank.

As used herein, the term “application programming interface” (API) may refer to computer code that allows communication between different systems or (hardware and/or software) components of systems. For example, an API may include function calls, functions, subroutines, communication protocols, fields, and/or the like usable and/or accessible by other systems or other (hardware and/or software) components of systems.

As used herein, the terms “communication” and “communicate” may refer to the reception, receipt, transmission, transfer, provision, and/or the like of information (e.g., data, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and communicates the processed information to the second unit. In some non-limiting embodiments, a message may refer to a network packet (e.g., a data packet and/or the like) that includes data. It will be appreciated that numerous other arrangements are possible.

As used herein, the term “computing device” may refer to one or more electronic devices that are configured to directly or indirectly communicate with or over one or more networks. The computing device may be a mobile device. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. The computing device may include a mobile device, such as a desktop computer. Furthermore, the term “computer” may refer to any computing device that includes the necessary components to receive, process, and output data, and normally includes a display, a processor, a memory, an input device, and a network interface.

As used herein, the terms “issuer institution,” “issuer,” or “issuer bank” may refer to one or more entities that provide accounts to customers for conducting transactions (e.g., payment transactions), such as initiating credit and/or debit payments. For example, an issuer institution may provide an account identifier, such as a personal account number (PAN), to a customer that uniquely identifies one or more accounts associated with that customer. The account identifier may be embodied on a payment device, such as a physical financial instrument, e.g., a payment card, and/or may be electronic and used for electronic payments. The terms “issuer institution” and “issuer institution system” may also refer to one or more computer systems operated by or on behalf of an issuer institution, such as a server computer executing one or more software applications. For example, an issuer institution system may include one or more authorization servers for authorizing a transaction.

As used herein, the term “merchant” may refer to an individual or entity that provides goods and/or services, or access to goods and/or services, to customers based on a transaction, such as a payment transaction. As used herein, the terms “merchant” or “merchant system” may also refer to one or more computer systems operated by or on behalf of a merchant, such as a server computer executing one or more software applications. As used herein, the term “point-of-sale (POS) system,” may refer to one or more computers and/or peripheral devices used by a merchant to engage in payment transactions with customers, including one or more card readers, near-field communication (NFC) receivers, RFID receivers, and/or other contactless transceivers or receivers, contact-based receivers, payment terminals, computers, servers, input devices, and/or other like devices that can be used to initiate a payment transaction.

As used herein, the term “merchant bank” or “lending institution” may refer to an individual or entity that engages in underwriting services, loan services, financial advising, fundraising services, and/or other banking services for merchants. For example, a merchant bank may review (e.g., approve, deny, and the like) and provide loans to merchants and charge an interest rate on the loaned amount. As used herein, the terms “merchant bank system” or “lending institution system” may also refer to one or more computer systems operated by or on behalf of the merchant bank, such as a server computer executing one or more software applications. For example, a merchant bank system may include one or more loan processing processors for reviewing loan requests from merchants.

As used herein, the term “payment device” may refer to an electronic payment device, a portable financial device, a payment card (e.g., a credit or debit card), a gift card, a smartcard, smart media, a payroll card, a healthcare card, a wristband, a machine-readable medium containing account information, a keychain device or fob, an RFID transponder, a retailer discount or loyalty card, a cellular phone, an electronic wallet mobile application, a personal digital assistant (PDA), a pager, a security card, a computer, an access card, a wireless terminal, a transponder, and/or the like. In some non-limiting embodiments, the payment device may include volatile or non-volatile memory to store information (e.g., an account identifier, a name of the account holder, and/or the like).

As used herein, the term “server” may refer to one or more computing devices (e.g., processors, storage devices, similar computer components, and/or the like) that communicate with client devices and/or other computing devices over a network (e.g., a public network, the Internet, a private network, and/or the like) and, in some examples, facilitate communication among other servers and/or client devices. It will be appreciated that various other arrangements are possible. As used herein, the term “system” may refer to one or more computing devices or combinations of computing devices (e.g., processors, servers, client devices, software applications, components of such, and/or the like). Reference to “a device,” “a server,” “a processor,” and/or the like, as used herein, may refer to a previously-recited device, server, or processor that is recited as performing a previous step or function, a different server or processor, and/or a combination of servers and/or processors. For example, as used in the specification and the claims, a first server or a first processor that is recited as performing a first step or a first function may refer to the same or different server or the same or different processor recited as performing a second step or a second function.

As used herein, the term “transaction service provider” may refer to an entity that receives transaction authorization requests from merchants or other entities and provides guarantees of payment, in some cases through an agreement between the transaction service provider and the issuer institution. In some non-limiting embodiments, a transaction service provider may include a credit card company, a debit card company, and/or the like. As used herein, the term “transaction service provider system” may also refer to one or more computer systems operated by or on behalf of a transaction service provider, such as a transaction processing server executing one or more software applications. A transaction processing server may include one or more processors and, in some non-limiting embodiments, may be operated by or on behalf of a transaction service provider.

As used herein, the term “user interface” or “graphical user interface” refers to a generated display, such as one or more graphical user interfaces (GUIs) with which a user may interact, either directly or indirectly (e.g., through a keyboard, mouse, etc.).

Existing systems that determine scores for individuals based on personal spending data cannot provide a sufficient or adequate assessment of merchants to avoid or reduce costly underwriting and review processing for loan approval for the merchants. For example, existing lending systems cannot provide real-time loan approval for merchants. As an example, existing lending systems or banks must perform expensive underwriting because they may not have access to clearing and settlement data for merchant transactions. In this way, existing lending systems have no mechanism that provides risk scoring and lending via a separate, centralized system integrated with partner banks and merchants, and existing lending systems cannot determine a peer-to-peer risk score for a merchant relative to similar merchants engaging in a similar market segment and/or being located in a similar geographic region. Existing systems are also ambiguous as to events that may make the merchant eligible for obtaining a loan during a future time period. For example, existing lending systems may inefficiently process loan requests from merchants without providing feedback to the merchants to reduce processing time for future lending processes and/or decisions.

Non-limiting embodiments or aspects of the present disclosure are directed to computer-implemented methods, systems, and products for processing loan requests from merchants. Non-limiting embodiments or aspects may provide risk scoring and lending via a separate, centralized system integrated with partner banks and merchants. In this way, non-limiting embodiments or aspects generate a peer-to-peer risk score for a merchant making a loan request in order to determine the risk associated with approving a loan for the merchant. The peer-to-peer risk score enables non-limiting embodiments or aspects to determine the risk for the merchant relative to similar merchants engaging in a same or similar market segment and/or being located in a same or similar geographic region such that a more accurate risk assessment associated with the loan for the merchant is providing while avoiding expensive and time-consuming underwriting processes. Non-limiting embodiments or aspects provide for generating trigger events for the merchant in response to a loan request to enable the merchant to more transparently understand the merchant activity that, during some future time period, may be performed or fulfilled in order for the requested loan to be approved. This not only enables the merchant to better understand how a loan may be obtained, but it may also avoid future costly underwriting and reviewing processes being reproduced for the same merchant loan request, enabling the loan processing system to operate more efficiently. Non-limiting embodiments or aspects also provide for tracking merchant activity and communicating merchant progress toward receiving a loan approval, such that the loan may be processed and/or provided as soon as the loan approval is achieved. This feature enables for more efficient processing, as the merchant is not required to re-submit a loan request, and the merchant may be immediately notified at the time events leading to the loan approval have been triggered.

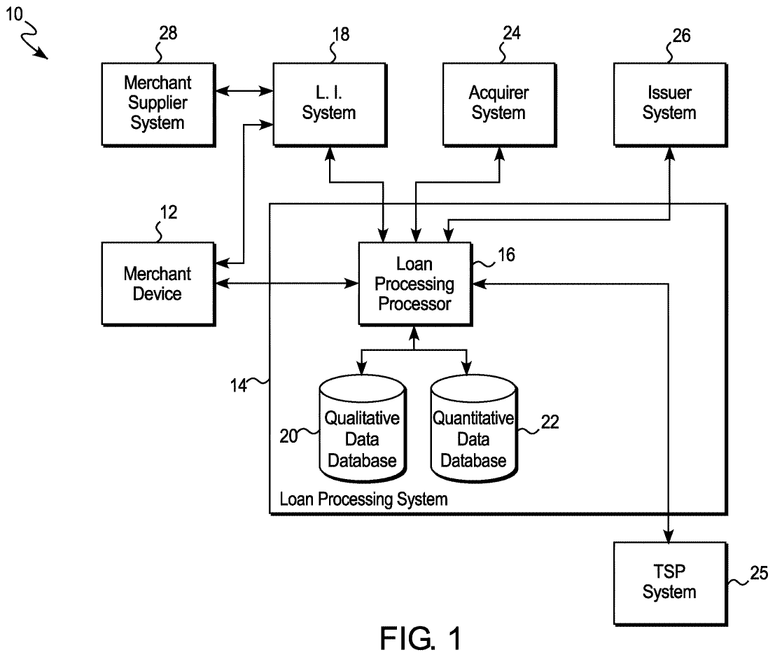

Referring to FIG. 1, a system 10 for processing a loan request according to some non-limiting embodiments or aspects is shown. The system 10 may include a merchant device 12 in communication with a loan processing system 14. The merchant device 12 may include a computing device associated with a merchant, such as a smartphone, tablet computer, laptop computer, and/or desktop computer of the merchant. The merchant may be a micro or small enterprise (MSE), having less than a threshold amount (e.g., less than $1M, etc.) in sales per year initiated using electronic payments (e.g., debit and/or credit card transactions). The merchant may be associated with a first geographic region. Being associated with a geographic region may include the merchant having a business location within the first geographic region, the merchant shipping product to customers within the first geographic region, the merchant performing services within the first geographic region, and/or the like. The first geographic region may be any arbitrarily defined geographic region and may include a district, village, municipality, parish, township, zip code, city, county, state, region, country, and/or the like.

The loan processing system 14 may be operated by or on behalf of a transaction service provider, issuer, acquirer, lending institution, or other third party entity engaging in loan processing. The loan processing system 14 may include a loan processing processor 16 for processing loan requests. The loan processing system 14 may include at least one database storing merchant data associated with merchants, including merchants communicating loan requests to the loan processing processor 16. The merchant data may include qualitative data and/or quantitative data associated with the merchants. The at least one database may include a qualitative data database 20 for storing qualitative data associated with merchants and a quantitative data database 22 for storing quantitative data associated with merchants. While illustrated in FIG. 1 as the qualitative data database 20 and the quantitative data database 22, it will be appreciated that these databases could be a single database, or further separated into two or more databases.

The qualitative data database 20 may store qualitative data associated with merchants. The qualitative data may include at least one of the following parameters: whether the merchant has a digital presence (e.g., a website URL, a presence through an online aggregator, or marketplace application, and/or the like), type of business and risk associated therewith, a number of years in business (e.g., based on the time the merchant began engaging in electronic payments, and/or the like), a number of operating locations, a social media presence (e.g., an account on Facebook, Twitter, Instagram, and/or the like) or a strength associated with the social media presence (e.g., number of social media followers, likes, and/or the like), online review sites (e.g., number of reviews and/or scores from reviewers from aggregator sites, Google, or any other merchant review website), types of business ownership (e.g., minority owned, female owned, military veteran owned, and/or the like), social or noble cause of the merchant (e.g., supplying meals to the poor, and/or the like); or any combination thereof.

The quantitative data database 22 may store quantitative data associated with merchants. The quantitative data may include data associated with a plurality of electronic transactions conducted by the merchant. The quantitative data may include at least one of the following parameters: merchant category code (MCC), percentage of market segment associated with the merchant in the geographic region of the merchant, annual sales volume (e.g., including profit volume), annual transaction volume (e.g., transaction count), e-commerce transactions (e.g., as a percentage of total transactions), growth rates (e.g., quarterly transaction volume, active card, sales volume growth rates), inbound transactions (e.g., cross-border transactions from another country) compared to total transaction count, share of electronic transactions (credit and/or debit card) compared to total sales volume, tenure of the merchant with acquirer or transaction service provider, chargeback/sales ratio (e.g., chargeback count/sales count), fraud ratios (e.g., fraud count over transaction count), spend per active card (e.g., total profit volume/total active cards), transaction per active card (e.g., total transaction volume/total active cards), spending behavior of the merchant; or any combination thereof.

The loan processing processor 16 may receive the qualitative and/or quantitative data from the qualitative data database 20 and/or the quantitative data database 22, and/or certain of this data may be stored within and/or received from other sources, such as from a lending institution (LI) system 18 operated by or on behalf of a lending institution, an acquirer system 24 operated by or on behalf of an acquirer, a TSP system 25 operated by or on behalf of a transaction service provider, and/or an issuer system 26 operated by or on behalf of an issuer, each of which may be in communication with the loan processing processor 16. For example, the merchant data associated with the merchants and relevant to processing loan requests may be obtained from any source storing such relevant data.

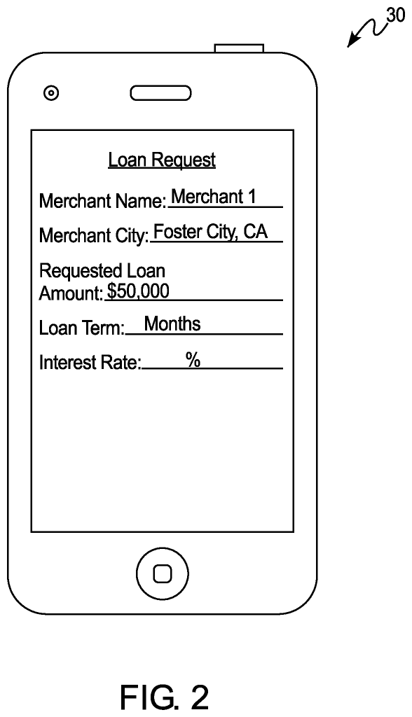

Referring to FIGS. 1 and 2, the merchant device 12 may communicate a loan request to the loan processing processor 16. FIG. 2 shows a graphical user interface displaying a loan request 30 according to some non-limiting embodiments or aspects. The loan request 30 may include a plurality of fields associated with the merchant, which the merchant may populate on the merchant device 12 in order to specify parameters of the loan request 30. The loan request 30 may include one or more of the following parameters: merchant name, merchant location, requested loan amount, requested loan term (e.g., loan duration), requested interest rate, or any combination thereof.

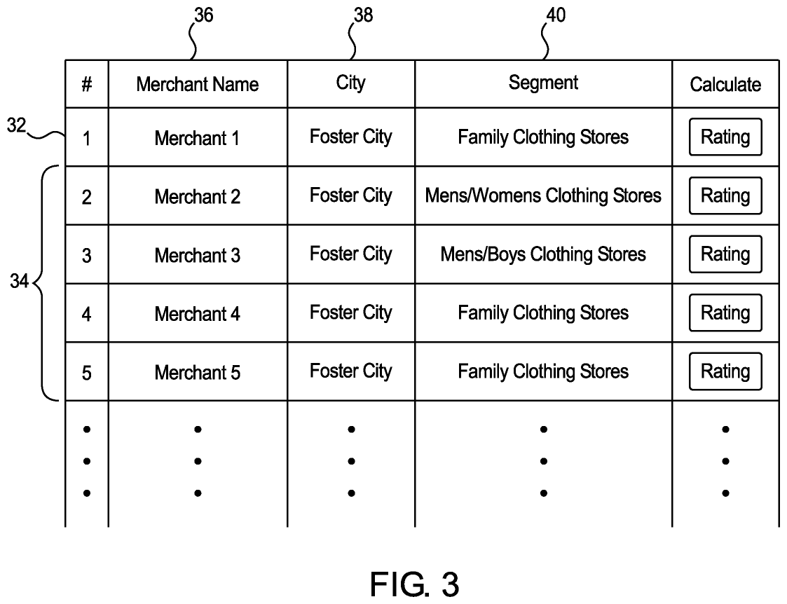

Referring to FIGS. 1 and 3, in response to receiving the loan request 30 (see FIG. 2) from the merchant device 12 of a first merchant 32 (which submitted the loan request 30), the loan processing processor 16 may determine a plurality of second merchants 34 in the same first geographic region of the first merchant 32 (e.g., in the same city, etc.). The plurality of second merchants 34 may be associated with a same and/or related market segment compared to the first merchant 32, such that the plurality of second merchants 34 sell similar goods and/or services compared to the first merchant 32. Merchants falling outside of the market segment and/or geographic region (e.g., not associated with the same market segment and/or the same geographic region) may be excluded from the plurality of second merchants 34. Similar market segment may be determined by MCC of the merchants, an overlap in at least one good and/or service provided by the merchants, a similarity or relatedness in the type of goods and/or services provided by the merchant, and/or any other similarity or relatedness between merchants. As shown in FIG. 3, the loan processing processor 16 may generate a list of a plurality of second merchants 34 associated with the first merchant 32, and the list may include merchant names 36, geographic location 38, and market segment 40 of the first merchant 32 and the plurality of second merchants 34. For example, as shown in FIG. 3, the loan processing processor 16 may determine that the first merchant 32 and the plurality of second merchants 34 are related because each merchant is associated with a same location (e.g., Foster City, Calif.) and has a same market segment (e.g., a market segment including selling clothing, such as family clothing, men's/women's clothing, men's/boy's clothing, and/or the like).

In response to receiving the loan request, the loan processing processor 16 may receive and/or determine the qualitative and/or the quantitative data associated with the first merchant 32 and the plurality of second merchants 34. For example, the loan processing processor 16 may determine that the first merchant and the plurality of second merchants (from a set of known merchants) are associated with a same first market segment of a plurality of market segments and/or the first geographic region according to the merchant data. The loan processing processor 16 may receive the qualitative and/or quantitative data from any of the qualitative data database 20, the quantitative data database 22, the LI system 18, the acquirer system 24, the TSP system 25, the issuer system 26, any other source, or any combination thereof.

Based on the qualitative and/or quantitative data, the loan processing processor 16 may generate a risk score associated with the first merchant 32. The risk score may be generated in real-time or near real-time relative to the loan request 30 (e.g., immediately in response to receipt of the loan request, etc.). The risk score may be a peer-to-peer risk score in that the risk score is generated for the first merchant relative to the plurality of second merchants 34. In some non-limiting embodiments or aspects, the qualitative and/or quantitative data for the first merchant 32 may be analyzed relative to the qualitative and/or quantitative data for the plurality of second merchants 34 to generate the peer-to-peer risk score.

The loan processing processor 16 may generate the peer-to-peer risk score based on relative weights assigned to the relevant qualitative parameters and/or quantitative parameters. The loan processing processor 16 may generate a qualitative score based on the qualitative parameters and a quantitative score based on the quantitative parameters, which scores may be assigned weights to determine the peer-to-peer risk score. The peer-to-peer risk score may be generated by considering the qualitative and/or quantitative parameters together. The weight assigned to the various parameters and/or the qualitative score and the quantitative score may be determined by analysis of qualitative and/or quantitative parameters, such as based on historical qualitative and/or quantitative data. In some non-limiting embodiments or aspects, the peer-to-peer risk score may be generated based on the qualitative and/or quantitative data associated with the first merchant 32 and the plurality of second merchants 34. To generate the peer-to-peer risk score for the first merchant 32 relative to the plurality of second merchants 34, relative principal component analysis (RCPA) may be performed on the qualitative and/or quantitative data to generate merchant scores for the first merchant 32. A composite score for the first merchant 32 may be obtained by applying the weights assigned to the various parameters. In some non-limiting embodiments or aspects, the weights may be assigned by the entity associated with the loan processing processor 16. In some non-limiting embodiments or aspects, the weights may be assigned based on historical merchant and/or loan data, such that the parameters that indicate the greater likelihood or probability of a loan being paid back are given a higher weight. For example, the loan processing processor 16 may utilize one or more machine learning algorithms to determine the weights to assign to the various parameters.

The peer-to-peer risk score may take any suitable form to convey a risk associated with making a loan to the first merchant 32 (e.g., a probability or likelihood of the first merchant 32 fulfilling the terms of the loan, such as repaying the loan with a predetermined amount of interest within a predetermined time period, etc.). For example, the peer-to-peer risk score may include a number rating, letter grade, pass/fail rating, a probability, a prediction, and/or other form of a score. In some non-limiting embodiments or aspects, the risk score may include a score on a 0-5 numerical scale, with a score of 0 indicating the highest risk merchants and a score of 5 indicating the lowest risk merchants. Any other scale may be used, however (e.g., 0-100 numerical scale, etc.) The loan processing processor 16 may communicate the peer-to-peer risk score to the merchant device 12 to notify the first merchant 32 of its peer-to-peer risk score.

The loan processing processor 16 may determine loan decision rules based on peer-to-peer risk scores. For example, the loan processing processor 16 may input the merchant and/or loan data and the peer-to-peer risk scores determined based on the historical merchant and/or loan data to a classification and regression tree (CART) model to generate the loan decision rules. The loan processing processor 16 may apply the loan decision rules to the peer-to-peer risk score for the first merchant 32 to determine a loan response, such as a dollar amount, an interest rate, a time period for repayment, a loan approval, a loan denial, and/or the like for the first merchant 32.

In some non-limiting embodiments or aspects, the loan processing processor 16 may periodically generate an updated peer-to-peer risk score associated with the first merchant 32 based on updated qualitative and/or quantitative data. The loan processing processor 16 may communicate the updated peer-to-peer risk score to the merchant device 12 periodically, such as daily, weekly, monthly, or as specified by the first merchant 32. The updated peer-to-peer risk score may be communicated to the merchant device 12 by any suitable means, such as an email, SMS text message, push notification in an application on the merchant device 12, and/or the like.

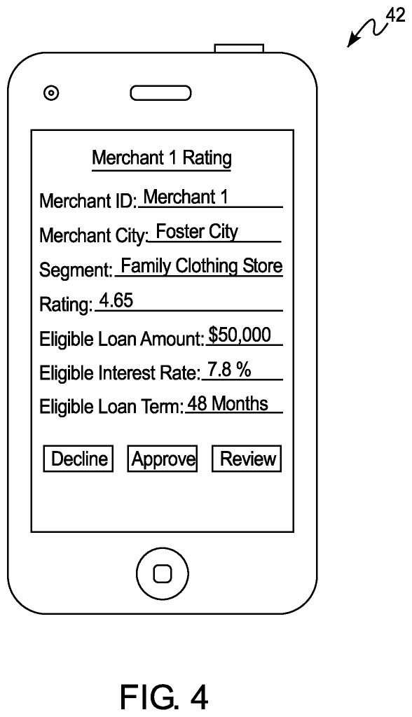

Referring to FIGS. 1 and 4, the loan processing processor 16 may generate a loan recommendation 42 associated with the loan request 30. The loan recommendation 42 may be generated in near real time relative to the loan request 30. The loan recommendation 42 may include the peer-to-peer risk score (e.g., the “Rating” from FIG. 4) associated with the first merchant 32. The loan processing processor 16 may also generate suggested loan terms for the first merchant 32 based on the peer-to-peer risk score. The suggested loan terms may include at least one of a recommended loan amount, a loan term (duration), an interest rate, or any combination thereof.

The loan processing processor 16 may communicate the loan recommendation 42 to the LI system 18. The LI system 18 may determine whether to approve, reject, review further, or alter the loan recommendation 42 and communicate the loan decision to the loan processing processor 16. In some non-limiting embodiments or aspects, the loan recommendation 42 does not include suggested loan terms but includes the peer-to-peer risk score. In such examples, the LI system 18 may generate loan terms based on the peer-to-peer risk score (e.g., using a look-up table, etc.) and communicate the loan terms to the loan processing processor 16. The LI system 18 may be in communication with the merchant device 12 or a merchant supplier system 28 operated by or on behalf of an entity supplying goods and/or services to the first merchant 32.

In some non-limiting embodiments or aspects, the loan processing processor 16 and the LI system 18 may communicate pre-determined loan terms prior to receiving the loan request 30. For example, the loan processing processor 16 may generate a loan recommendation 42 based on the peer-to-peer risk score and the pre-determined loan terms for any subsequently received loan request 30, such that the loan processing processor 16 may forego communicating the loan recommendation 42 to the LI system 18 for approval thereof (e.g., because the pre-determined loan terms may constitute a pre-approval).

The loan processing processor 16 may generate a loan decision based on the peer-to-peer risk score. The loan decision may also be based on the communication between the loan processing processor 16 and the LI system 18 regarding the loan recommendation 42. The loan decision may include, but is not limited to: approving the loan as requested, rejecting the loan, requesting further information to make a final loan decision, rejecting the requested loan but approving a loan having alternative terms, rejecting the loan while including a trigger event that may qualify the merchant for the loan terms or alternative loan terms, and/or the like.

In some non-limiting embodiments or aspects, the loan request 30 from the first merchant 32 may be rejected by the LI system 18 and/or the loan processing processor 16, such that the first merchant 32 is not eligible for a loan consistent with the requested loan terms in the loan request 30. The loan processing processor 16 and/or the LI system 18 may determine alternate loan terms different from the loan terms from the loan request 30 (e.g., different loan amount, loan term (duration), and/or interest rate) for which a loan for the first merchant 32 would be approved.

In some non-limiting embodiments or aspects, the loan request 30 from the first merchant 32 may be rejected by the LI system 18 and/or the loan processing processor 16, such that the first merchant 32 is not eligible for a loan consistent with the requested loan terms. The loan processing processor 16 and/or the LI system 18 may determine a trigger event that if completed by the first merchant 32 during a first time period would cause the first merchant 32 to be eligible for the loan terms from the loan request 30 or for alternative loan terms generated by the LI system 18 and/or the loan processing processor 16. The trigger event may be based on the peer-to-peer risk score. The trigger event may include any relevant activity or event determined by the LI system 18 and/or the loan processing processor 16 to make the first merchant 32 qualified for the loan terms. Non-limiting examples may include, but are not limited to, a count or value of sales made during the first time period, the creation of a merchant website during the first time period, a percent growth over the first time period, the addition of a new location during the first time period, and/or the like. The loan decision may be based on completion of the trigger event during the first time period.

During the first time period, the loan processing processor 16 may monitor activity associated with the first merchant 32 to determine whether the first merchant 32 completes the trigger event during the first time period. The loan processing processor 16 may communicate update messages to the merchant device 12 notifying the first merchant 32 of its progress towards satisfying the trigger event during the first time period, so that first merchant 32 is aware of how close it is to being approved for the loan. The update messages may include an updated peer-to-peer risk score based on more recent qualitative and/or quantitative data. The updated messages may be communicated periodically, such as daily, weekly, monthly, or as specified by the first merchant 32.

Upon detecting completion of the trigger event during the first time period, the loan processing processor 16 may generate an updated loan decision, which may include an approval of the loan request based on the trigger event being satisfied. The loan processing processor 16 may communicate this updated loan decision to the merchant device 12.

Upon determining that the trigger event was not completed during the first time period, the loan processing processor 16 may generate an updated trigger event that if completed by the first merchant 32 during a second time period causes the first merchant 32 to be eligible for the requested loan terms or alternative loan terms. The loan processing processor 16 may communicate an update message to the merchant device 12 including the updated trigger event and may monitor activity associated with the first merchant 32 to determine whether the first merchant 32 completes the updated trigger event during the second time period.

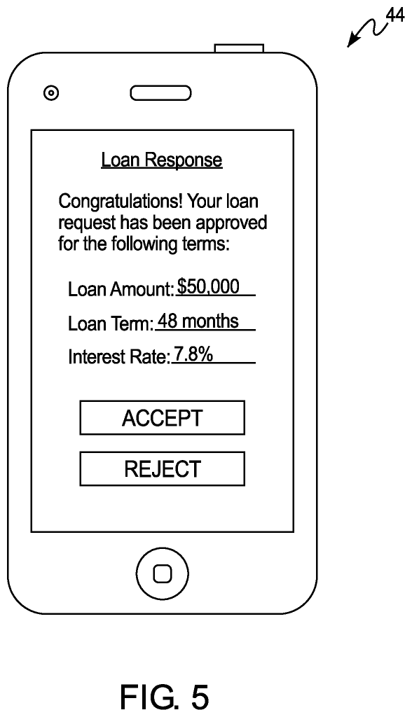

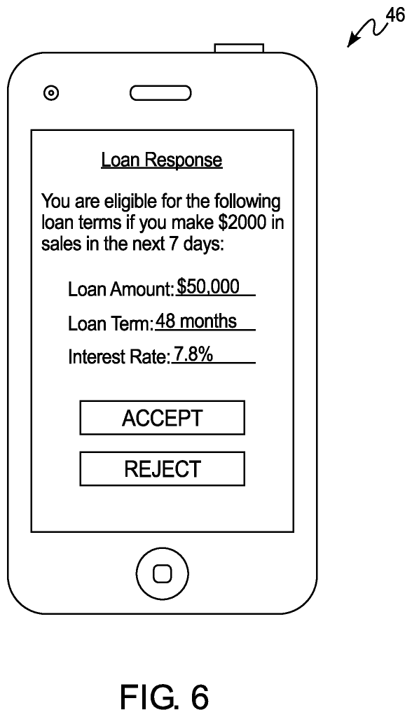

Referring to FIGS. 5 and 6, upon generating the loan decision, the loan processing processor 16 may communicate a loan response to the merchant device 12. The loan response may include the loan decision.

Referring to FIG. 5, a loan response 44 according so some non-limiting embodiments or aspects is shown. The loan response 44 communicated from the loan processing processor 16 to the merchant device 12 and displayed thereon may notify the first merchant 12 that the loan request 30 has been approved, either for the requested terms or for alternate terms (e.g., because the requested terms were rejected). The loan response 44 may include the terms associated with the loan for which the first merchant 32 was approved, such as the loan amount, loan term (duration), and/or interest rate. The merchant device 12 may display the loan response 44 with response fields (e.g., response buttons) that enable the first merchant 32 to indicate that the loan terms in the loan response 44 are accepted or rejected.

In response to the first merchant 32 accepting the loan terms in the loan response (e.g., via an accept message communicated from the merchant device 12 to the loan processing processor 16), the loan processing processor 16 may cause the LI system 18 to initiate a transfer for the loan amount from an account of the lending institution to an account of the first merchant 32 or to an account of a supplier of the first merchant.

Referring to FIG. 6, a loan response 46 according so some non-limiting embodiments or aspects is shown. The loan response 46 may be communicated from the loan processing processor 16 to the merchant device 12 and displayed thereon to notify the first merchant 32 that completion of a trigger event is required in order for the loan having the requested loan terms or alternate loan terms to be approved (e.g., because the requested loan terms were rejected at the present time without the trigger event occurring). The loan response 46 may include the terms associated with the loan for which the first merchant 32 would be approved, such as the loan amount, loan term (duration), and/or interest rate, should the trigger event ($2000 in sales) be completed during the first time period (the next 7 days). The merchant device 12 may display the loan response 46 with response fields (e.g., response buttons) that enable the first merchant 32 to indicate that the loan terms in the loan response 46 are accepted or rejected should the first merchant 32 complete the trigger event during the first time period. The merchant device 12 may display a loan response with response fields (e.g., response buttons) after the trigger event has been completed by the first merchant to enable the first merchant to accept or reject the loan terms included in the loan response based on the first merchant 32 having completed the trigger event.

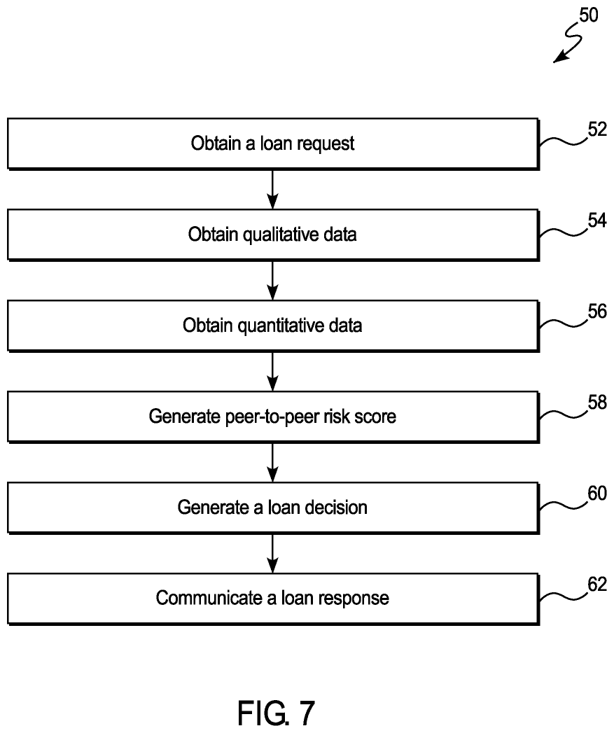

Referring to FIG. 7, a computer-implemented method 50 for processing a loan request according to some non-limiting embodiments or aspects is shown. At a step 52, the loan processing processor 16 may obtain a loan request for a first amount associated with a first merchant in a first geographic region. At a step 54, the loan processing processor 16 may obtain qualitative data associated with the first merchant and a plurality of second merchants in the first geographic region. At a step 56, the loan processing processor 16 may obtain quantitative data associated with the first merchant and the plurality of second merchants, wherein the quantitative data is associated with a plurality of electronic transactions by the first merchant and the plurality of second merchants. At a step 58, the loan processing processor 16 may generate, based on the qualitative data and the quantitative data (e.g., based on merchant data), a peer-to-peer risk score associated with the first merchant, wherein the peer-to-peer risk score associated with the first merchant is determined relative to the plurality of second merchants. At a step 60, the loan processing processor 16 may, based on the peer-to-peer risk score associated with the first merchant, generate a loan decision for the first merchant. At a step 62, the loan processing processor 16 may communicate a loan response to the first merchant, the loan response comprising the loan decision.

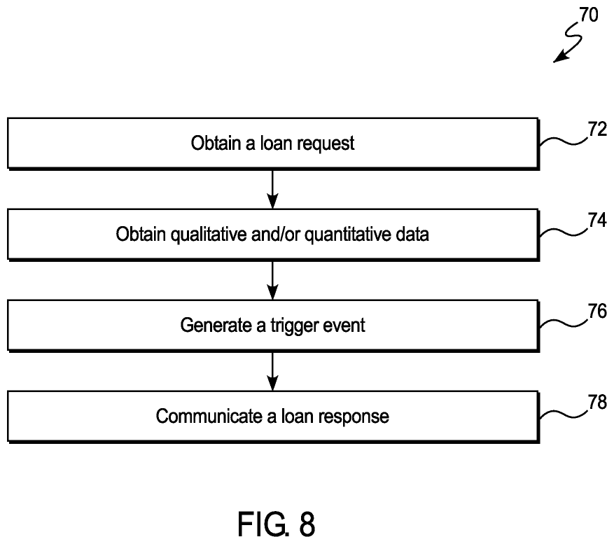

Referring to FIG. 8, a computer-implemented method 70 for processing a loan request according to some non-limiting embodiments or aspects is shown. At a step 72, the loan processing processor 16 may obtain a loan request for a first amount associated with a first merchant in a first geographic region. At a step 74, the loan processing processor 16 may obtain qualitative and/or quantitative data associated with the first merchant, wherein the qualitative data is associated with a plurality of electronic transactions by the first merchant. At a step 76, the loan processing processor 16 may generate, based on the qualitative data and/or the quantitative data (e.g., based on merchant data), a trigger event that, if completed by the first merchant during a first time period, causes the first merchant to be eligible for a loan for the first amount. At a step 78, the loan processing processor 16 may communicate a loan response to the first merchant, the loan response comprising the trigger event.

In some further, non-limiting embodiments or aspects, a computer program product for processing a loan request includes at least one non-transitory computer readable medium including program instructions that, when executed by at least one processor, cause the at least one processor to execute one of the previously-described systems and/or methods. The at least one processor may include at least one of the loan processing processor 16 and the LI system 18.

Although the disclosure has been described in detail for the purpose of illustration based on what is currently considered to be the most practical and preferred embodiments, it is to be understood that such detail is solely for that purpose and that the disclosure is not limited to the disclosed embodiments, but, on the contrary, is intended to cover modifications and equivalent arrangements that are within the spirit and scope of the appended claims. For example, it is to be understood that the present disclosure contemplates that, to the extent possible, one or more features of any embodiment can be combined with one or more features of any other embodiment.

What is claimed is:

1. A computer-implemented method, comprising:
obtaining, with at least one processor, a loan request for a first amount associated with a first merchant in a first geographic region;
obtaining, with at least one processor, merchant data associated with the first merchant and a plurality of second merchants;
generating, with at least one processor and based on the merchant data, a peer-to-peer risk score associated with the first merchant, wherein the peer-to-peer risk score associated with the first merchant is determined relative to the plurality of second merchants;
based on the peer-to-peer risk score associated with the first merchant, generating, with at least one processor, a loan decision for the first merchant; and
communicating, with at least one processor, a loan response to the first merchant, the loan response comprising the loan decision.

2. The computer-implemented method of claim 1, further comprising:
determining, with at least one processor, that the first merchant and the plurality of second merchants are associated with a same first market segment of a plurality of market segments and/or the first geographic region.

3. The computer-implemented method of claim 1, wherein the loan decision comprises an approval of the loan request, and wherein the method further comprises:
controlling, with at least one processor, a lending system to transfer the first amount from an account associated with the lending system to an account associated with the first merchant or an account associated with a supplier of the first merchant.

4. The computer-implemented method of claim 1, wherein the loan decision comprises an initial denial of the loan request, and wherein the method further comprises:
determining, with at least one processor, an alternate loan amount based on the peer-to-peer risk score associated with the first merchant.

5. The computer-implemented method of claim 1, wherein the loan decision comprises an initial denial of the loan request, and wherein the method further comprises:
determining, with at least one processor, a trigger event that, if completed by the first merchant during a first time period, causes the first merchant to be eligible for a loan for the first amount.

6. The computer-implemented method of claim 5, further comprising:
determining, with at least one processor, that the first merchant completes the trigger event during the first time period; and
communicating an updated loan decision to the first merchant in response to the first merchant completing the trigger event during the first time period.

7. The computer-implemented method of claim 5, further comprising:
determining, with at least one processor, that the first merchant fails to complete the trigger event during the first time period;
determining, with at least one processor, an updated trigger event that, if completed by the first merchant during a second time period, causes the first merchant to be eligible for a loan for the first amount; and
communicating an update message to the first merchant, the update message comprising the updated trigger event.

8. The computer-implemented method of claim 1, wherein the loan decision comprises an initial denial of the loan request, wherein the method further comprises:
periodically generating, with at least one processor, an updated peer-to-peer risk score associated with the first merchant; and
communicating, with at least one processor, the updated peer-to-peer risk score associated with the first merchant to the first merchant.

9. The computer-implemented method of claim 1, wherein the merchant data comprises qualitative and/or quantitative data associated with the first merchant and the plurality of second merchants, wherein the quantitative data is associated with a plurality of electronic transactions by the first merchant and/or the plurality of second merchants.

10. A computer-implemented method, comprising:
obtaining, with at least one processor, a loan request for a first amount associated with a first merchant in a first geographic region;
obtaining, with at least one processor, merchant data associated with the first merchant;
generating, with at least one processor and based on the merchant data, a trigger event that, if completed by the first merchant during a first time period, causes the first merchant to be eligible for a loan for the first amount; and
communicating, with at least one processor, a loan response to the first merchant, the loan response comprising the trigger event.

11. The computer-implemented method of claim 10, further comprising:
obtaining, with at least one processor, merchant data associated with a plurality of second merchants in the first geographic region; and
generating, with at least one processor and based on the merchant data, a peer-to-peer risk score associated with the first merchant, wherein the peer-to-peer risk score associated with the first merchant is determined relative to the plurality of second merchants,
wherein the trigger event is generated based on the peer-to-peer risk score.

12. The computer-implemented method of claim 11, further comprising:
determining, with at least one processor, that the first merchant and the plurality of second merchants are associated with a same first market segment of a plurality of market segments and/or the first geographic region.

13. The computer-implemented method of claim 10, further comprising:
determining, with at least one processor, that the first merchant completes the trigger event during the first time period; and
communicating a loan approval to the first merchant in response to the first merchant completing the trigger event during the first time period.

14. The computer-implemented method of claim 10, further comprising:
determining, with at least one processor, that the first merchant fails to complete the trigger event during the first time period;
determining, with at least one processor, an updated trigger event that, if completed by the first merchant during a second time period, causes the first merchant to be eligible for a loan for the first amount; and
communicating an update message to the first merchant, the update message comprising the updated trigger event.

15. The computer-implemented method of claim 11, further comprising:
periodically generating, with at least one processor, an updated peer-to-peer risk score associated with the first merchant; and
communicating, with at least one processor, the updated peer-to-peer risk score associated with the first merchant to the first merchant.

16. The computer-implemented method of claim 11, wherein the merchant data comprises qualitative and/or quantitative data associated with the first merchant, wherein the quantitative data is associated with a plurality of electronic transactions by the first merchant and/or the plurality of second merchants.

17. A system, comprising at least one processor programmed and/or configured to:
obtain a loan request for a first amount associated with a first merchant in a first geographic region;
obtain merchant data associated with the first merchant and a plurality of second merchants;
generate, based on the merchant data, a peer-to-peer risk score associated with the first merchant, wherein the peer-to-peer risk score associated with the first merchant is determined relative to the plurality of second merchants;
based on the peer-to-peer risk score associated with the first merchant, generate a loan decision for the first merchant; and
communicate a loan response to the first merchant, the loan response comprising the loan decision.

18. The system of claim 17, wherein the loan decision comprises an approval of the loan request, and wherein the at least one processor is further programmed and/or configured to:
control a lending system to transfer the first amount from an account associated with the lending system to an account associated with the first merchant or an account associated with a supplier of the first merchant.

19. The system of claim 17, wherein the loan decision comprises an initial denial of the loan request, and wherein the at least one processor is further programmed and/or configured to:
determine an alternate loan amount based on the peer-to-peer risk score associated with the first merchant,
wherein the loan response comprises the alternate loan amount.

20. The system of claim 17, wherein the loan decision comprises an initial denial of the loan request, and wherein the at least one processor is further programmed and/or configured to:
determine a trigger event that, if completed by the first merchant during a first time period, causes the first merchant to be eligible for a loan for the first amount.
